(19) United States
(12) Patent Application Publication
(10) Pub. No.: US 2005/0014126 A1
(43) Pub. Date: Jan. 20, 2005

(54) Passive load bearing system and method of using

(76) Inventors: James D. Segermark, Gem Lake, MN (US); Steven Wiesner, San Jose, CA (US); Douglas Wilkins, San Jose, CA (US)

Correspondence Address: Richard C. Emery, 4189 Lakewood Avenue, White Bear Lake, MN, 55110-3925, US

(21) Appl. No.: 10/816,286

(22) Filed: Apr. 1, 2004

Related U.S. Application Data
(60) Provisional application No. 60/459,713, filed on Apr. 2, 2003.

(51) Int. Cl. F16L 1/00; B65D 1/00; B32B 1/08; B29D 22/00; B29D 23/00; G09B 1/00; A47B 41/00

(52) U.S. Cl. 434/433

(57) ABSTRACT

The invention provides a system and method for temporarily increasing the mass of an animal's body. The invention is useful both as a means of correcting an animal's existing body condition as well as preventing an adverse change to its body condition.

### CROSS REFERENCE TO RELATED APPLICATIONS

This application claims the benefit of Provisional Application 60/459,713 filed Apr. 02, 2003, which is herein incorporated in its entirety.

### FIELD OF THE INVENTION

The present invention provides a system and method for temporarily increasing the mass of an animal's body. The invention is useful both as a means of correcting an animal's existing body condition as well as preventing an adverse change to its body condition.

### BACKGROUND OF THE INVENTION

The weight or mass of a person or animal is a function of its size, and is directly proportional to its volume. One cubic centimeter of water has a mass of one gram (under standard conditions). Animals, including humans, are predominantly water, so, with the combined mass from body fat, muscle tissue, and skeletal structure, humans are equal in mass to about one gram per cubic centimeter.

Gaining weight increases pressure on the body and the body responds to the increased stress on bone and other tissue by increasing the density of the endoskeletal structure to support weight gain. Specifically, rather than the body keeping the same proportions to support the increased pressure, the support structures (bones) become denser to support the pressure. One example of gaining weight through increased pressure on the body is by lifting objects that are greater than one gram per cubic centimeter than the muscles that are lifting the weight. Humans exercise their muscles by repeatedly lifting over-weighted objects, or by moving an apparatus that provides resistance, simulating the movement of weight. Many machines and apparatus that are designed to place a load of weight on a specific muscle group exist and are commonly known as exercise machines. (See for example, U.S. Pat. 6,652,429, issued to Bushnell, and U.S. Pat. No. 4,236,712, issued to Lambert, Jr., the teachings of which are both incorporated herein by reference.) Losing body weight decreases the pressure on the body and results in a person's endoskeletal structure becoming frail. Animals lose weight by combining increased movement with a reduction in their nutritional intake. Animals also lose weight by using nutritional supplements found in nature, artificially produced pharmaceuticals, and other chemicals that consume more calories for the body to digest. These products and methods create a net loss of body mass, including the loss of bone tissue. (See U.S. Pat. No. 6,204,291, issued to Sunvold, et al., and U.S. Pat. No. 5,055,460, issued to Friedlander, the teachings of which both are incorporated herein by reference.) A lever is a simple machine that magnifies force. Levers are comprised of a rigid bar (lever arm) a pivot point (fulcrum), a load force, and an effort force. The effort force creates a torque around the fulcrum. The magnitude of this torque is dependant on the magnitude of the force and its distance from the fulcrum. This torque must be balanced by the torque created by the load force. Changing the distance from the fulcrum to the load force changes the amount of force magnification. The body of animals, and specifically the endoskeletal structure of humans, works as multiple levers when a load force is introduced to the body.

Three main types of levers exist: first-class, second-class, and third-class.

A first-class lever has the fulcrum located between the effort force and the load force on the lever arm. An example of a first-class lever is a seesaw.

A second-class lever has the effort located between the fulcrum and the load on the lever arm. An example of a second-class lever is a wheelbarrow.

A third-class lever has the effort located between the load and the fulcrum. An example of this type of lever is a human forearm lifting a weight.

An endoskeletal animal has support structures (bones) located within its body to provide rigidity and facilitate movement against gravity. Bones and associated structures are used in ordinary life as first, second and third class levers by lifting, pushing, pulling etc. Muscles are attached to and cause bones to move. For a muscle to move an appendage in one direction a separate opposing muscle or muscle group must exist to be able to move the appendage in a different direction.

Muscles thus work together, simultaneously stretching and lengthening corresponding (opposing) muscles or groups of muscles. Tight or toned muscles on one side of the bone can cause the other side to over stretch and weaken. Muscles that are more developed on one side of the body than the other consequently lead to physical imbalance of the body in general, and create problems for continued bone development, and degradation over the life of the animal. Anatomical imbalance of muscles and repetition of any activity (including general movement) leads to problems with proper movement and performance of ordinary tasks.

Increasingly, the condition of osteoporosis (the loss of bone density) in animals has become prevalent for a variety of natural (internal) and environmental (external) reasons. External reasons, among others, include the use of substances to balance hormones in females and males, and the loss of weight with and without exercise. Natural causes, among others, include the combined reduction of proper nutrition for the body and heavy lifting in the daily regimen of humans and other endoskeletal animals. Bone density can only be increased or maintained during a period of weight loss or weight maintenance by increasing gravity on the bones.

The use of weighted apparatus' being worn on the body to increase resistance or increase gravity is not new. For example, an “ankle weight” apparatus is a known and commonly used form of exercise equipment. The weighted apparatus is placed far from the knee joint, above the foot of an animal. As the motion of walking, running or jumping moves the weighted apparatus, the load force to the knee joint is magnified, or increased, in an unnatural, non-dispersed fashion. Gravity on a specific body part is not increased as all of the weight is transferred to the joint. Another weighted body apparatus is a “weight vest” or “weight belt” that is placed around the torso of a person or animal. This weighted apparatus simply works to lower the center of gravity, placing stress on the lower back and transferring the weight to the hip and knee joints. It is commonly used to help buoyant peoples and animals become less buoyant when intending to swim under the surface of water with the use of an under-water breathing apparatus. The known weighted devices of these types are worn transiently with indifference to the muscles, muscle groups, and skeletal structure that is being impacted. What is clearly therefore needed are methods and devices that can increase the mass of an animal's body in specific areas to achieve a safe and desired outcome.

### BRIEF DESCRIPTION OF THE DRAWINGS

FIG. 1 shows a front view of a human body, identifying the appendage joints.

FIG. 2 shows a front view of a human body, identifying the midjoint areas.

FIG. 3 shows a front view of a human body having the present invention emplaced thereon.

FIG. 4 shows a top view of an embodiment of a weight used in the present invention.

FIG. 5 shows a side view of the weight shown in FIG. 4.

FIG. 6 shows a top view of a composite weight.

FIG. 6a shows a side view of the composite weight of FIG. 6.

FIG. 7 shows a top view of another embodiment of a composite weight.

FIG. 8 shows a perspective view of the composite weight embodiment shown in FIG. 7.

FIG. 9 shows a top view of an alternative embodiment of a composite weight.

FIG. 10 shows a side view of the composite weight embodiment shown in FIG. 9.

FIG. 11 shows a front view of an upper body garment with long sleeves having means to receive weights.

FIG. 12 shows a front view of a long legged pair of trousers having means to receive weights.

FIG. 13 shows a front view of an upper body garment with short sleeves having means to receive weights.

FIG. 14 shows a front view of a pair of short trousers having means to receive weights.

FIG. 15 shows a front view of a pair of trousers with mid-length legs having means to receive weights.

FIG. 16 shows a side view of a stocking having means to receive weights.

FIG. 17 shows a top view of an embodiment of a weight used in the present invention.

FIG. 18 shows a side view of the weight shown in FIG. 17.

FIG. 19 shows a top view of a composite weight.

FIG. 20 shows a side view of the composite weight of FIG. 19.

FIG. 21 shows a top view of another embodiment of a composite weight.

FIG. 22 shows a perspective view of the composite weight embodiment shown in FIG. 21.

FIG. 23 shows a top view of an alternative embodiment of a composite weight.

FIG. 24 shows a side view of the composite weight embodiment shown in FIG. 23.

FIG. 25 shows a view of a weight surgically implanted into a human arm.

FIG. 26 shows a pocket attached to a long sleeved upper body garment.

### SUMMARY OF THE INVENTION

The present invention contemplates a passive load bearing system and method that can be externally worn or surgically implanted. In accordance with the present invention, the passive load bearing system and method is based on the principle that opposing muscle groups, both individually and on the corresponding side of the body, must be exercised to keep a body fit, balanced and healthy. The present invention can assist in correcting the imbalance in an animal that is born with such an unbalanced condition, or prophylactic use of the present invention can help to avert this condition by increasing muscle mass and bone density. Normal motion and growth of an animal with the present invention implanted under its skin, or used externally by such an animal will balance the muscles and skeletal system when used correctly during active and passive muscle movement. Use of the system and method by an animal with an endoskeleton strengthens corresponding muscle groups, increases bone density, and helps to maintain or increase body balance. Accordingly, with use of the present invention when losing weight, the density of bones and tissue will be maintained or increased, and the support structures (bones) will continue to remain healthy, avoiding osteoporosis.

In one embodiment, the invention comprises a method of passively loading an endoskeletal animal's body to increase gravity and mass. The invention comprises the steps of placing a weight at a midjoint area of an appendage of the animal and then securing the weight to the midjoint area.

In another embodiment, the invention comprises a method of passively loading an endoskeletal animal's body to increase gravity and mass. The invention comprises the steps of determining a midjoint location of an appendage where a weight is required to treat the animal. Also, a mass of the weight required to treat the animal is determined. The length of time necessary for treatment is also determined. The weight is placed at a midjoint area of an appendage of the animal and the weight is secured to the midjoint area of an appendage.

In a further embodiment, the invention comprises a method of externally passively loading an endoskeletal animal's body to increase gravity and mass. The invention comprises the steps of determining a midjoint location on an appendage where a weight is required to treat the animal. The mass of the weight required to treat the animal is determined. The period of time necessary for treatment is also determined. A garment having a weight receiving means at the determined midjoint location is provided. The determined weight is inserted into the weight receiving means. The weight is secured in the weight receiving means and the animal dons the garment for the determined period of time.

In still another embodiment, the invention comprises a system for externally passively loading an animal's body. The system includes a garment covering at least one midjoint area of an animal's appendage, with at least one pocket incorporated into the at least one midjoint area for receiving a weight. At least one weight is inserted into the pocket.

In yet another embodiment the invention comprises a method of internally passively loading an endoskeletal animal's body to increase body and mass. The invention comprises the steps of determining a midjoint location on an appendage where a weight is required to treat the animal. A mass of the weight required to treat the animal is selected and determined. A period of time necessary for treatment is also determined. An incision is made proximate the midjoint location which exposes the first layer of muscle. The weight is inserted around the muscle under the layers of skin and fascia and sutured at the site of insertion through grommets in the weight. Upon insertion of the weight, the incision is closed.

In another embodiment, the invention comprises a system for passively loading an animal's body. The system comprises a flexible substrate and at least one sub-weight. Encapsulation contains the at least one sub-weight and attached to the flexible substrate.

### DETAILED DESCRIPTION

Definitions

“Appendage” refers to an arm or leg of an endoskeletal animal.

“Joint” refers to an articulation between two or more bones of an appendage of an endoskeletal animal.

“Midjoint” refers to a point between two joints of an appendage of a normal animal.

“Weight” means an object weighing more than 1 gram per cubic centimeter or a composite object comprising a plurality of single objects weighing more than 1 gram per cubic centimeter attached to a substrate material.

Nomenclature

10 Weight (generic)
20 Planar Sub-Weight
22 Substrate
24 Composite Weight
25 Breathable Encapsulation Material
26 Cylindrical Sub-Weight
28 Substrate
30 Breathable Encapsulation Material
29 Composite Weight
32 Spherical Sub-Weight
34 Substrate
36 Breathable Encapsulation Material
37 Composite Weight
38 Long Sleeved Upper Body Garment
40 Pocket
41 Closure Flap
42 Long Legged Trousers
44 Short Sleeved Upper Body Garment
46 Short Legged Trousers
48 Mid-Length Trousers
49 Stocking
50l Shoulder Joint (left)
50r Shoulder Joint (right)
51l First Midjoint Area (left)
51r First Midjoint Area (right)
52l Elbow Joint (left)
52r Elbow Joint (right)
53l Second Midjoint Area (left)
53r Second Midjoint Area (right)
54l Wrist Joint (left)
54r Wrist Joint (right)
55l Third Midjoint Area (left)
55r Third Midjoint Area (right)
56l Hip Joint (left)
56r Hip Joint (right)
57l Fourth Midjoint Area (left)
57r Fourth Midjoint Area (right)
58l Knee Joint (left)
58r Knee Joint (right)
60l Ankle Joint (left)
60r Ankle Joint (right)
110 Weight (generic)
120 Planar Sub-Weight
122 Substrate
124 Composite Weight
125 Impenetrable Encapsulation Material
126 Cylindrical Sub-Weight
127 Grommet
128 Substrate
130 Impenetrable Encapsulation Material
129 Composite Weight
132 Spherical Sub-Weight
134 Substrate
136 Impenetrable Encapsulation Material
137 Composite Weight
   Construction

Specifically, the invention comprises a system and method of placing increased, symmetrically balanced passive load bearing weights in specific anatomical locations that can be worn externally on, or implanted in, the body of animals with an endoskeleton. By doing so the gravitational pull on the body increases and the corresponding density of the endoskeleton and the mass of the organism increases. The corresponding increase in endoskeletal mass is no different than the normal response of the body to weight increase and decrease that occurs throughout the course of an animal's natural life.

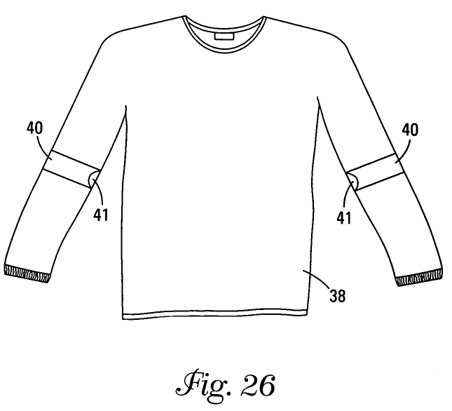

The external embodiment of the weight 10, 20, 24, 26, 29, 32, 37 is made of any substance with the effective mass of greater than one gram per one cubic centimeter. Such materials include, but are not limited to carbon, tungsten, stainless steel, or other minerals or combinations of minerals that exist in nature. As an example, Carbon steel has a relative true density of 7.9 grams per cubic centimeter. Zirconium oxide has a relative true density of 5.5 grams per cubic centimeter and zirconium silicate has a relative true density of 4.5 grams per cubic centimeter. Materials such as these are examples of substances that could be used for incorporation in practicing the passive load bearing system and method. In the external embodiment, the weight 10, 20, 24, 26, 29, 32, 37 is encapsulated in a breathable material 25, 30, 36 to alleviate the buildup of moisture on the surface of the animal's appendage. The external embodiment can be symmetrical or asymmetrical as required by the animal's condition and can be tailored to fit to the size of an individual animal to meet the need for proper continued placement. Proper placement of the passive load device on and around the body is important to avoid potential muscle imbalance or inappropriate stress on joints and tendons. The present invention rectifies this potential problem by ensuring secure placement of the weight 10, 20, 24, 26, 29, 32, 37, at the midjoint area 51l, 51r, 53l, 53r, 55l, 55r, 57l, 57r of an appendage and dispersing the weight 10, 20, 24, 26, 29, 32, 37, around the body part in equal fashion. The weight 10, 20, 24, 26, 29, 32, 37 is firmly secured to the body to eliminate any potential slipping. The external embodiment incorporates the weight 10, 20, 24, 26, 29, 32, 37, into commonly worn garments such as stockings 49, long legged trousers 42, mid-calf trousers 48, mid-thigh shorts 46, and long 38 and short 44 sleeved upper body garments (e.g., shirts). In a preferred embodiment, the external weight 10, 20, 24, 26, 29, 32, 37 fits into a specially designed circumferential pocket 40 in the appropriate midjoint location of the various garments 38, 42, 44, 46, 48, 49. The pocket 40 may be provided with a closure flap 41 as seen in FIG. 26. The closure flap 41 may be provided with securing means such as hook and loop fastening material (not shown). The present invention further contemplates securing the weight(s) 10, 20, 24, 26, 29, 32, 37 to externally worn garments 38, 42, 44, 46, 48, 49 by other means, including, but not limited to, hooks, hook and loop fastener (not shown), buttons (not shown), snaps (not shown), elastic (not shown) and permanent or temporary adhesives (not shown).

Also contemplated by and therefore within the scope of the invention is a harness device (not shown) provided with means for receiving the weight 10, 20, 24, 26, 29, 32, 37 that is worn underneath regular clothing.

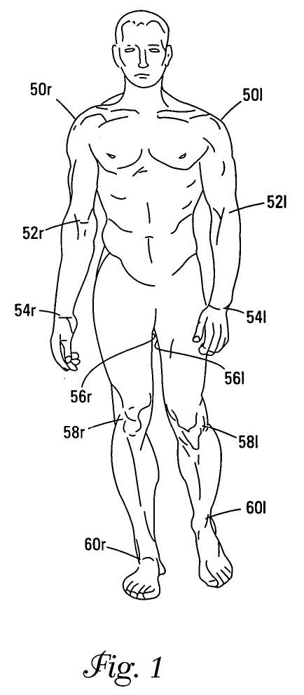

FIG. 1 shows a normal, intact human body (unnumbered) and identifies the appendage joints as shoulder 50l, 50r, elbow 52l, 52r, wrist 54l, 54r, hip 56l, 56r, knee 58l, 58r, and ankle 60l, 60r. In cases of abnormality or amputation, not all limbs and/or joints may be present in a human body.

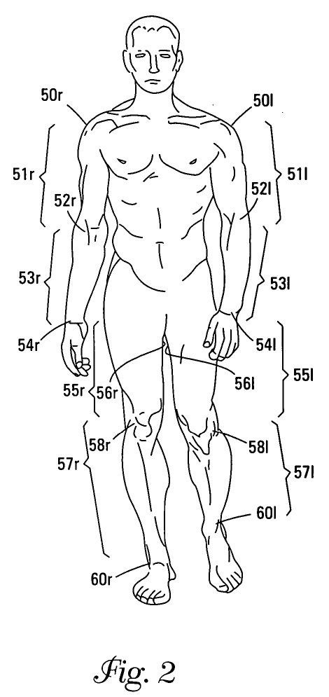

FIG. 2 defines the first midjoint area 51l, 51r as between the shoulder 50l, 50r and elbow 52l, 52r. The second midjoint area 53l, 53r is the area extending between the elbow 52l, 52r and the wrist 54l, 54r. The third midjoint area 55l, 55r extends between the hip 56l, 56r and knee 58l, 58r. The fourth midjoint area 57l, 57r likewise extends between the knee 58l, 58r and the ankle 60l, 60r. In identifying the midjoint areas 51l, 51r, 53l, 53r, 55l, 55r, 57l, 57r it is intended that the area extends between the sequential areas of a particular limb, for example, the area between 581 and the ankle 601.

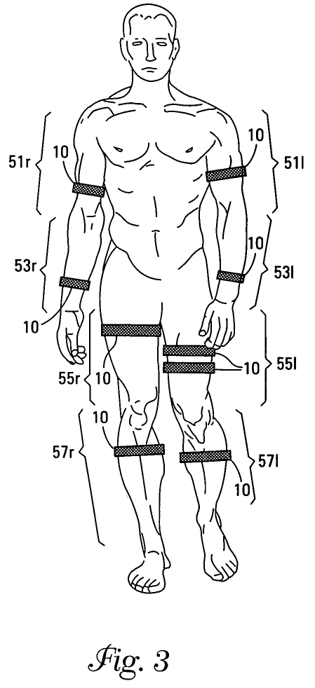

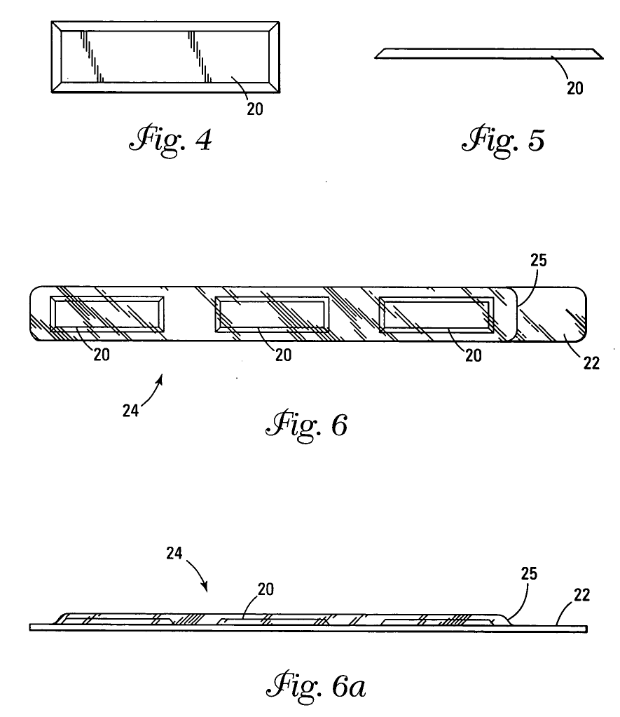

FIG. 3 shows a normal, intact human body (unnumbered) following external placement of weights 10 at the midjoint areas 51l, 51r, 53l, 53r, 55l, 55r, 57l, 57r. It should be mentioned that the designation for weight 10 as used in FIG. 3 represents weights 20, 24, 26, 29, 32, 37 of any configuration that meet the criteria specified herein, and is included to illustrate proper placement and should therefore not be considered limiting. As shown in FIG. 4 and FIG. 5, the weight 20 can be of a planar nature and used alone. In an alternative embodiment, as shown in FIG. 6 and FIG. 6a, the individual planar weights 20 could also be attached to a substrate 22 which may be flexible in nature to form a composite weight unit 24. The composite weight unit 24 is covered with a breathable encapsulation material 25. In a preferred embodiment, the breathable encapsulation material 25 is made of a breathable fabric such as nylon, cotton or other well known materials that can be sewn together or sealed with an adhesive or heat application, to provide encapsulation. In an alternative embodiment, the weight 20, 26, 32 could be placed inside a polymeric extrusion and the extrusion could then be sealed using known techniques such as heat sealing. In each of these embodiments, the encapsulated weight 20, 26, 32 is mounted to a substrate 22, 28, 34 either before or after encapsulation. The substrate 22, 28, 34 would be used for accurate and easy placement of the passive load bearing system. In the internally emplaced embodiments, biocompatible materials would need to be used to prevent infection and other complications occurring as a result of a foreign object being implanted into the body. This includes the encapsulating, weighted and substrate components.

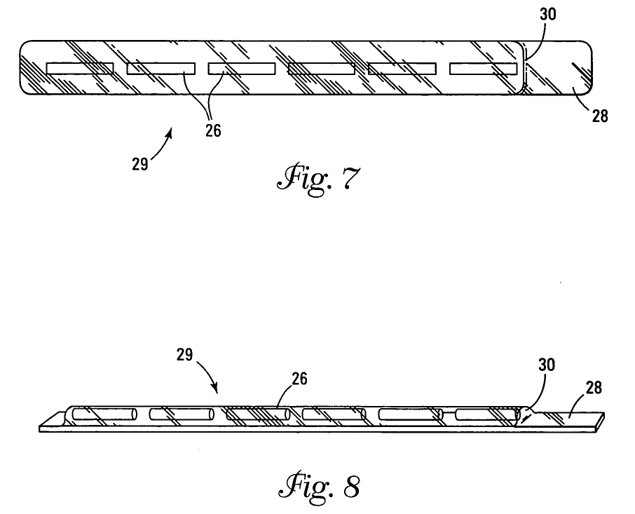

An additional weight embodiment is shown in FIG. 7 and FIG. 8, in which a cylindrical weight 26 is attached to a substrate 28. An encapsulating material 30 covers the cylindrical weights 26 to form composite weight 29.

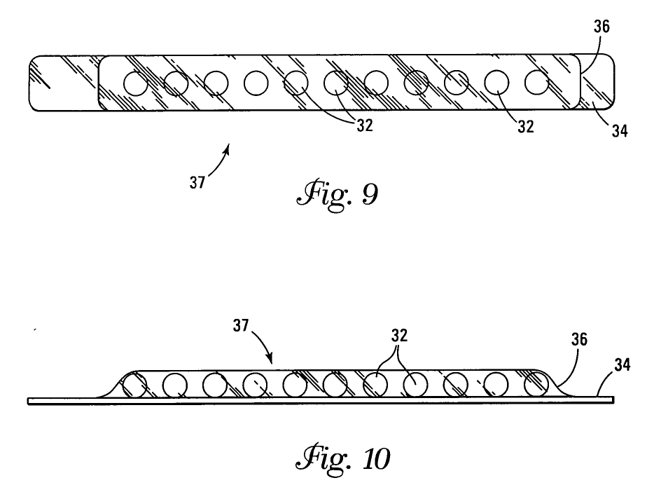

Yet another weight embodiment is shown in FIG. 9 and FIG. 10 wherein a spherical weight 32 is attached to a substrate 34. A breathable encapsulating material 36 covers the spherical weights 32 to form a composite weight 37.

The above embodiments of weights 10, 20, 24, 26, 29, 32, 37, are intended to be illustrative in nature only and therefore not limiting the scope of the invention. In reality, any shape or kind of weight meeting the criteria as discussed herein could be used. It should be further mentioned that the invention contemplates the composite weights 24, 29, 37, 124, 129, 137 as having the corresponding individual weights 20, 26, 32, 120, 126, 130 loosely received within the encapsulation material 25, 30, 36, 125, 130, 136. This embodiment allows the composite weights 24, 29, 37, 124, 129, 137 to be self centering when the animal moves, thus more facilitating more equitable weight distribution.

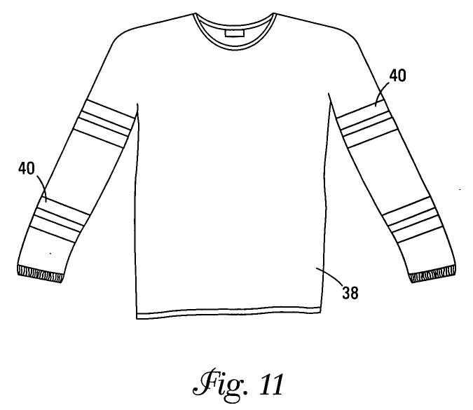

FIG. 11 shows a long sleeved upper body garment 38 which is provided with a pocket 40 to receive a weight 10, 20, 24, 26, 29, 32, 37 at the first 51l, 51r and second 53l, 53r midjoint areas of the arm. As discussed above, other weight receiving means include hooks, hook-and-loop fastening material, buttons, snaps, elastic, permanent or temporary adhesives. Additionally, any type of fastener capable of securing a weight to a particular location on an item of clothing is also considered to be within the scope of the present invention.

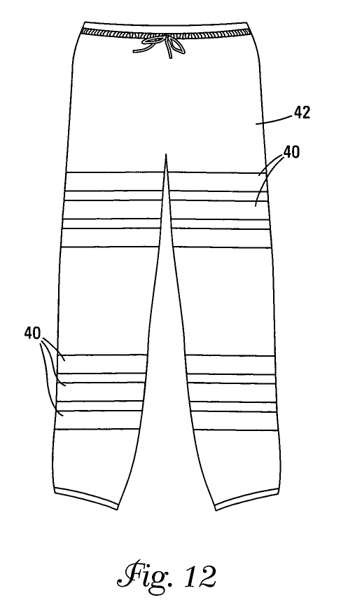

FIG. 12 shows a long-legged pair of trousers 42 provided with pocket 40 at the first 55l, 55r and second 57l, 57r midjoint areas.

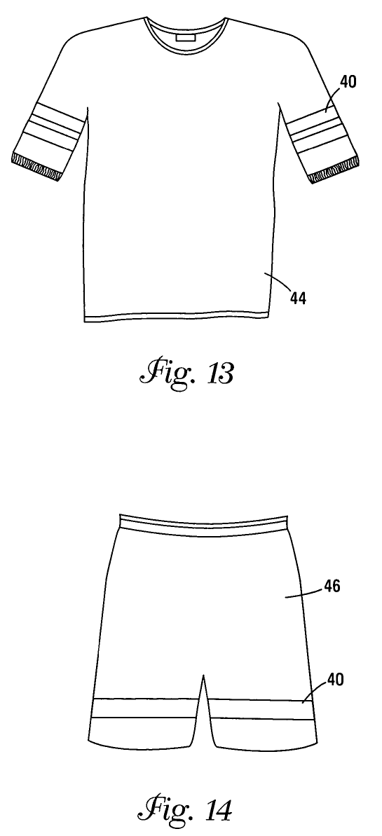

FIG. 13 shows a short sleeved upper garment 44 provided with pocket 40 at the first midjoint area 51l, 51r.

FIG. 14 shows a short legged pair of trousers 46 provided with pocket 40 at the third midjoint area 55l, 55r.

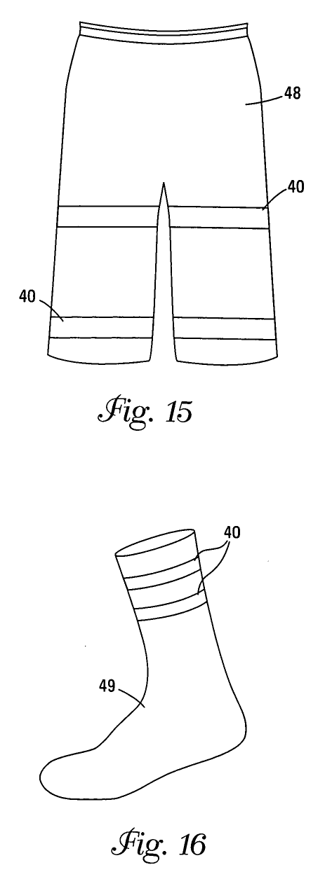

FIG. 15 shows a mid length pair of trousers 48 provided with pocket 40 at the third 55l, 55r and fourth 57l, 57r midjoint areas.

FIG. 16 shows a stocking 49 provided with pocket 40 at the fourth midjoint area 57l, 57r.

As discussed above, the invention contemplates garments that are commonly worn, however the commonly known garments do not have a pocket 40 for receiving weight(s) 10, 20, 24, 26, 29, 32, 37 located in the midjoint area(s) 51l, 51r, 53l, 53r, 55l, 55r, 57l, 57r. In the external embodiment, the method is used with such a garment to insure that the fulcrum effect is eliminated and the entire passive load is equally and preferentially circumferentially dispersed around the appendage.

The external passive load bearing device is modular in design, such that weight(s) 10, 20, 24, 26, 29, 32, 37 can be added or subtracted and balance around the appendage is maintained. To achieve this we envision the system and method utilizing equal amounts of weight placed into a segment of flexible, possibly molded material, and other segments of similar or more weight could be placed over, or instead of the first encapsulation to gain, or subtract weight.

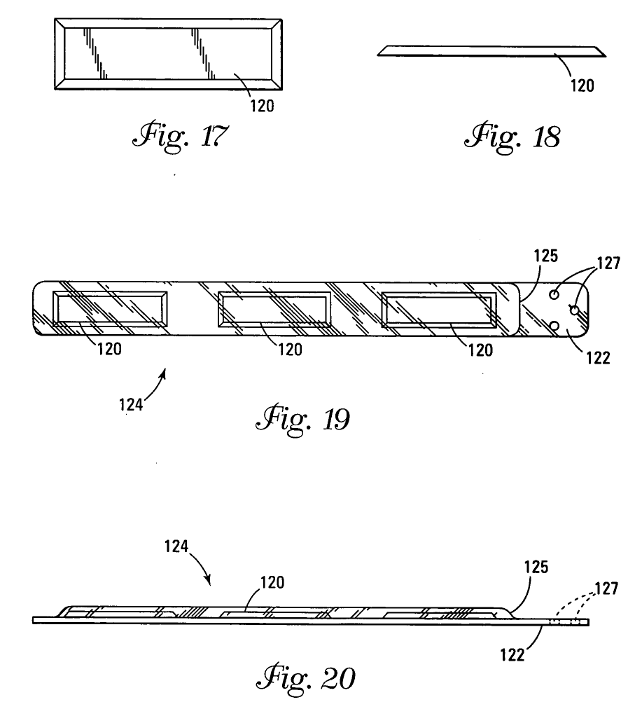

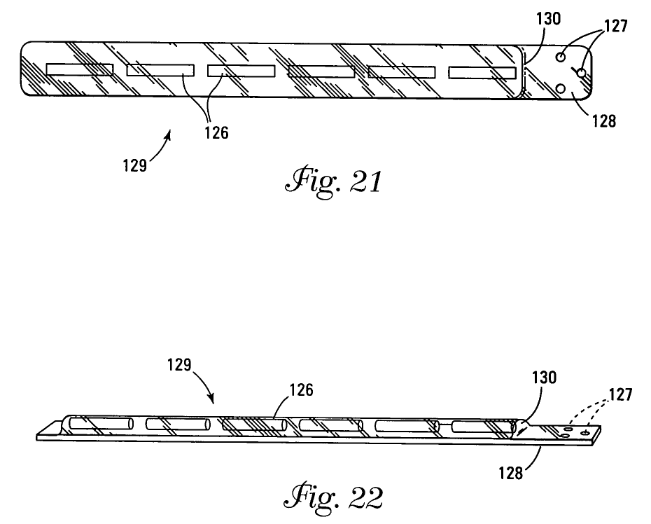

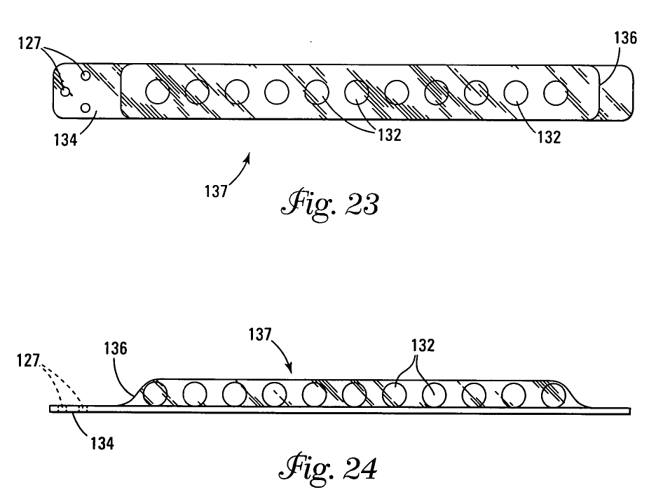

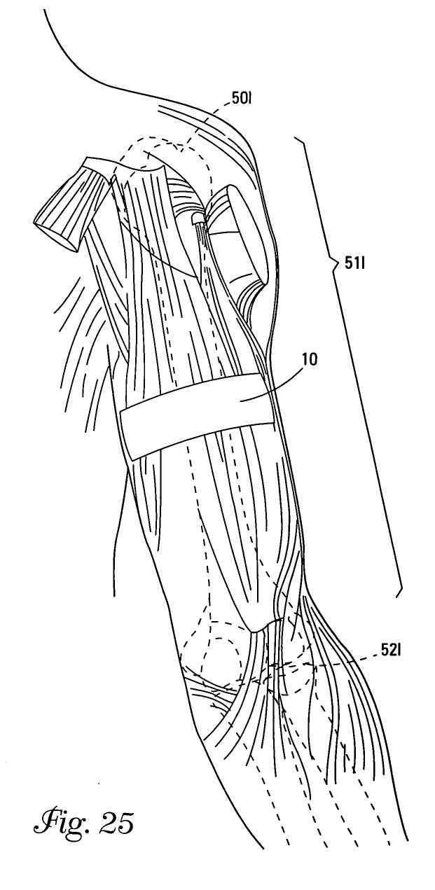

The implantable embodiment is placed permanently or temporarily under the skin and anchored in muscle tissue in the midjoint areas 51l, 51r, 53l, 53r, 55l, 55r, 57l, 57r to properly weight and balance the tissue and skeleton. As shown in FIGS. 17-24 the implantable weight 124, 129, 137 is encapsulated 125, 130, 136 in biocompatible material with grommets 127 extending through the substrate 122, 128, 134 for guiding sutures to maintain proper placement and ease of removal of the weight 124, 129, 137. The implantable weight 124, 129, 137 is made of known biocompatible materials that are used in cardiac pacemakers, synthetic joints, breast implants or other implantable grade materials known to the medical community. Examples of such materials include but are not limited to stainless steel, nickel-titanium alloys and other commonly known materials that do not create an irritation or reaction with animal tissue or blood. The devices could also be made of implantable, biocompatible materials that are not yet known. For proper results and to avoid destroying the ergonomic nature of the body, the weight 124, 129, 137 has a mass of greater than one gram per one cubic centimeter. This is greater than the mass of the animal that it is placed in.

Surgical Placement. Using well known and practiced surgical techniques, a sterile field is created, and an incision appropriate in length made in the skin of the animal, deep enough to expose the first layer of muscle in the animal. The device is then inserted around and over the muscle tissue, under the layers of skin, and other fascia, in a circumferential fashion, by pushing the composite weight 124, 129, 137 into the surgically created space. Further dissection of any adhesions of the fascia to the muscle may be required. The composite weight 124, 129, 137 is then adhered to the muscle tissue using a dissolving suture, ligament or other cordlike structure, by sewing it through the grommets 127 in the substrate 122, 128, 134 and surrounding the composite weight 124, 129, 137 in the location on only one end—the end of the device that is seen after inserting the composite weight 124, 129, 137. The composite weight 124, 129, 137 can then be externally manipulated to verify further correct placement. As shown in FIG. 25, the weight 10 extends around the first midjoint area (left) 511 under the patient's skin (unnumbered), over the layers of muscle (unnumbered) and bone (unnumbered).

Use

Practicing the system and method involves determining the amount of mass required and the anatomical location(s) on the animal's body where the weight is required and also the length of time necessary for treatment. The appropriate weight is then selected and placed at and secured to the appropriate midjoint location on the animal's appendage for the determined length of treatment.

In the case of the external embodiment, the animal dons the appropriate item(s) of clothing (fitted with the appropriate weight 10, 20, 24, 26, 29, 32, 37 in the appropriate location) as directed by the physician, veterinarian, physical therapist, or trainer for the duration of treatment. Following completion of treatment, the garment 38, 42, 44, 46, 48, 49 is simply removed.

In the case of the implantable embodiment, the physician or veterinarian follows the implantation procedure described above and surgically implants the appropriate composite weight 124, 129, 137 in the appropriate location. The implanted composite weight 124, 129, 137 is then secured as described above and the incision closed. FIG. 25 shows the composite weight 124, 129, 137 following implantation in a patient. Following completion of treatment, the physician or veterinarian re-exposes the composite weight 124, 129, 137, removes the implanted composite weight 124, 129, 137 and closes the incision following normal procedures.

1. A method of passively loading an endoskeletal animal's body to increase gravity and mass, comprising the steps of:
a. placing a weight at a midjoint area of an appendage of the animal; and
b. securing the weight.

2. The method of claim 1 wherein the weight has a mass of greater than one gram per cubic centimeter.

3. The method of claim 2 wherein the weight is attached to a garment.

4. The method of claim 3 wherein the weight is attached to the garment by being inserted into a pocket in the garment.

5. The method of claim 4 wherein the pocket is circumferentially disposed on the garment.

6. The method of claim 2 wherein the weight is encapsulated in an impervious biocompatible material.

7. The method of claim 6 wherein the weight is surgically implanted under the skin and over the muscle tissue of an animal.

8. The method of claim 2 wherein the weight comprises:
a. a flexible substrate;
b. at least one sub-weight; and
c. encapsulation containing the at least one sub-weight and attached to the flexible substrate.

9. A method of passively loading an endoskeletal animal's body to increase gravity and mass, comprising the steps of:
a. determining a midjoint location of an appendage where a weight is required to treat the animal;
b. determining a mass of the weight required to treat the animal;
c. determining a length of time necessary for treatment;
d. placing the weight at a midjoint area of an appendage of the animal; and
e. securing the weight.

10. The method of claim 9 wherein the weight has a mass of greater than one gram per cubic centimeter.

11. The method of claim 10 wherein the weight is attached to a garment.

12. The method of claim 11 wherein the weight is attached to the garment by being inserted into a pocket in the garment.

13. The method of claim 12 wherein the pocket is circumferentially disposed on the garment.

14. The method of claim 10 wherein the weight is encapsulated in an impervious biocompatible material.

15. The method of claim 14 wherein the weight is surgically implanted under the skin and over the muscle tissue of an animal.

16. The method of claim 9 wherein the weight comprises:
a. a flexible substrate;
b. at least one sub-weight; and
c. encapsulation containing the at least one sub-weight and attached to the flexible substrate.

17. A method of externally passively loading an endoskeletal animal's body to increase gravity and mass, comprising the steps of:
a. determining a midjoint location on an appendage where a weight is required to treat the animal;
b. determining a mass of the weight required to treat the animal;
c. determining a period of time necessary for treatment;
d. providing a garment having a pocket at the determined midjoint location;
e. inserting the determined weight into the pocket;
f. securing the weight in the weight receiving means; and
g. donning the garment by the animal for the determined period.

18. The method of claim 17 wherein the pocket is circumferentially disposed on the garment.

19. The method of claim 17 wherein the weight has a mass of greater than one gram per cubic centimeter.

20. A system for externally passively loading an animal's body, comprising:
a. a garment covering at least one midjoint area of an animal's appendage;
b. at least one pocket incorporated into the at least one midjoint area for receiving a weight; and
c. at least one weight inserted into the pocket.

21. The system of claim 20 wherein the weight has a mass of greater than one gram per cubic centimeter.

22. The system of claim 20 wherein the weight comprises:
a. a flexible substrate;
b. at least one sub-weight; and
c. encapsulation containing the at least one sub-weight and attached to the flexible substrate.

23. The system of claim 20 wherein the pocket is circumferentially disposed on the garment.

24. A method of internally passively loading an endoskeletal animal's body to increase body and mass, comprising the steps of:
a. determining a midjoint location on an appendage where a weight is required to treat the animal;
b. determining and selecting a mass of the weight required to treat the animal;
c. determining a period of time necessary for treatment;
d. making an incision proximate the midjoint location;
e. exposing the first layer of muscle;
f. inserting the weight around the muscle under the layers of skin and fascia;
g. suturing the weight at the site of insertion through grommets in the weight; and
h. closing the incision.

25. The method of claim 24 wherein the weight is circumferentially inserted around the muscle.

26. The method of claim 24 wherein the weight has a mass of greater than one gram per cubic centimeter.

27. The method of claim 26 wherein the weight comprises:
a. a flexible substrate;
b. at least one sub-weight; and
c. encapsulation containing the at least one sub-weight and attached to the flexible substrate.

28. The method of claim 27 wherein the encapsulation is impenetrable.

29. A system for passively loading an animal's body, comprising:
a. a flexible substrate;
b. at least one sub-weight; and
c. encapsulation containing the at least one sub-weight and attached to the flexible substrate.

30. The system of claim 29 wherein the encapsulation contains a plurality of sub-weights.

31. The system of claim 30 wherein the plurality of sub-weights are loosely disposed within the encapsulation so as to be self-centering.

32. The system of claim 29 wherein the flexible substrate is provided with at least one grommet.
